(19) United States
(12) Patent Application Publication
(10) Pub. No.: US 2012/0008882 A1
(43) Pub. Date: Jan. 12, 2012

(54) FLUID HANDLING SYSTEM

(75) Inventors: Greg K. Justice, Vancouver, WA (US); Ronald J. Ender, Corvallis, OR (US); Craig L. Malik, Corvallis, OR (US)

(73) Assignee: Hewlett-Packard Development Company LP

(21) Appl. No.: 13/235,452

(22) Filed: Sep. 18, 2011

Related U.S. Application Data
(63) Continuation of application No. PCT/US2009/039219, filed on Apr. 1, 2009.

(51) Int. Cl. B65D 33/24; F16K 31/44

(52) U.S. Cl. 383/43; 251/213

(57) ABSTRACT

A fluid handling system includes a valve assembly within a needle that is movable from a closed state to an open state against a bias while engaging and moving a valve stem of a fluid supply from a closed state to an open state.

### CROSS-REFERENCE TO RELATED PATENT APPLICATIONS

The present application is a continuation of co-pending PCT/US2009/39219 filed on Apr. 1, 2009 by Greg K. Justice, Ronald J. Ender and Craig L. Malik, and entitled FLUID HANDLING SYSTEM, the full disclosure of which is hereby incorporated by reference.

### BACKGROUND

Fluid supplies supply fluid to fluid consuming devices. Connecting and disconnecting such fluid supplies to the fluid consuming devices and expelling fluid from the fluid supply may involve complex, space consuming and expensive components. Providing adequate seals to inhibit drying of the fluid within the fluid supply as well as the fluid receiver may also be difficult, resulting in dried fluid partially occluding fluid passages.

### BRIEF DESCRIPTION OF THE DRAWINGS

FIG. 1 is a fragmentary sectional view of a fluid handling system with a plunger and a fluid supply in a closed state according to an example embodiment.

FIG. 2 is a fragmentary sectional view of the fluid handling system of FIG. 1 with a fluid receiver in an open state and a fluid supply in a closed state according to an example embodiment.

FIG. 3 is a fragmentary sectional view of the fluid handling system of FIG. 1 with the plunger in an open state and the fluid supply in an open state according to an example embodiment.

FIG. 4 is a schematic illustration of another embodiment of the fluid handling system of FIG. 1 in a disconnected state according to an example embodiment.

FIG. 5 is a schematic illustration of the fluid handling system of FIG. 4 in a connected state according to an example embodiment.

FIG. 6 is a perspective view of another embodiment of the fluid handling system of FIG. 4 in a connected state according to an example embodiment.

FIG. 7 is a bottom perspective view of a portion of a fluid handling system of FIG. 6 according to an example embodiment.

FIG. 8 is a sectional view of a fluid receiver of the fluid handling system of FIG. 6 according to an example embodiment.

FIG. 9 is a fragmentary side elevation of view of the fluid handling system of FIG. 1 in the connected state, with portions omitted for purposes of illustration, according to an example embodiment.

FIG. 10 is a sectional view of the fluid handling system of FIG. 1 in the connected state according to an example embodiment.

FIG. 11 is a fragmentary sectional view of the fluid receiver disconnected from a fluid supply of the system of FIG. 6 according to an example embodiment.

### DETAILED DESCRIPTION OF THE EXAMPLE EMBODIMENTS

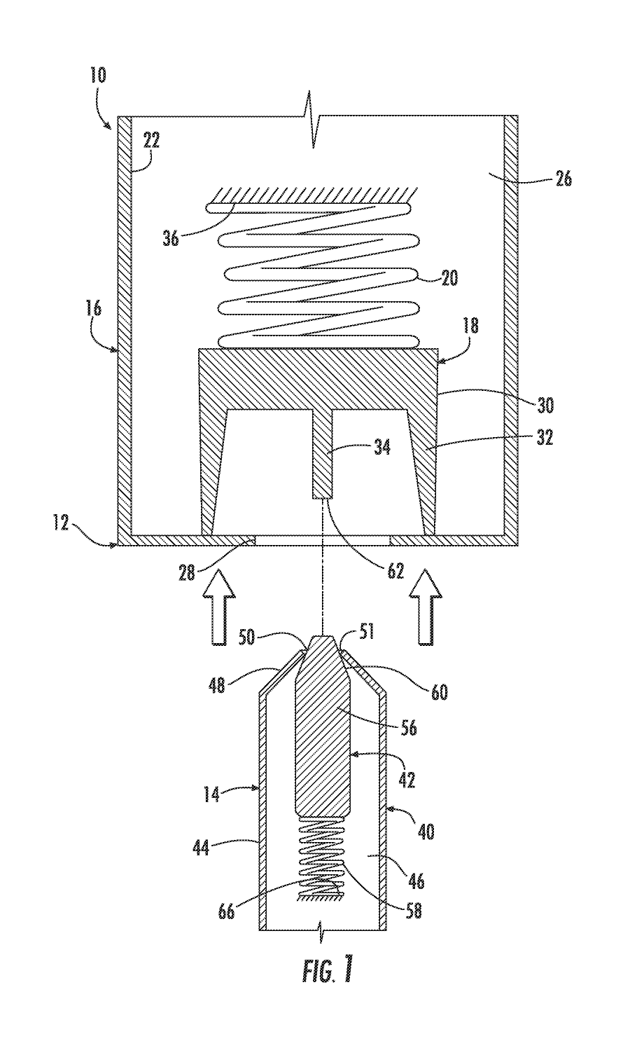

FIGS. 1-3 are fragmentary sectional views illustrating portions of a fluid handling system 10 according to an example embodiment. Fluid handling system 10 is configured to facilitate the flow or transfer of liquid or fluid from a fluid source or fluid supply to a fluid receiver or fluid consuming device. As will be described hereafter, fluid handling system 10 provides an interface between a fluid supply and a fluid receiver that is less susceptible to leakage and that inhibits drying of the fluid within the fluid supply as well as the fluid receiver in a compact and inexpensive manner

Fluid handling system 10 comprises fluid supply 12 and fluid receiver 14. Fluid supply 12 includes container 16, valve stem 18 and bias 20. Container 16 comprises an enclosure, body or other structure having one or more walls 22 forming an interior 26 containing a supply of liquid. Container 16 includes an opening 28 configured to receive at least portions of fluid receiver 14 when fluid supply 12 is connected to fluid receiver 14. Although illustrated as rectangular, fluid supply 16 may have a variety of sizes, shapes and configurations.

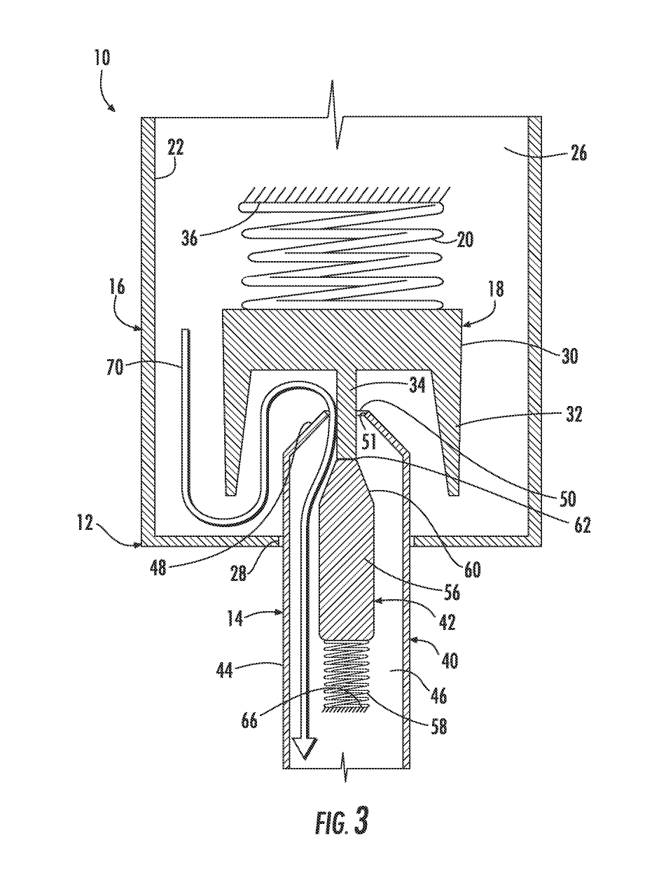

Valve stem 18 comprises a member movably supported within or proximate to container 16 for movement between a sealing or closed state (shown in FIG. 1) and an open state (shown in FIG. 3). Valve stem 18 includes body 30, blade 32 and pin 34. Body 30 is imperforate and supports blade 32 and pin 34. Blade 32 extends from body 30 and is configured to sealingly contact and engage container 16 to seal off or close off opening 28 of container 16 from a remainder of container 16. Blade 32 extends completely and continuously about opening 28. Pin 34 projects from body 30 and is configured to be received by needle 40 of fluid receiver 14.

Bias 20 comprises a member or structure configured to resiliently bias valve stem 18 towards the closed position or state shown in FIG. 1. In the example illustrated, bias 20 comprises a compression spring captured between valve stem 18 and an opposite stationary or grounding surface 36. In other embodiments, bias 20 may have other configurations or may be provided at other locations.

Fluid receiver 14 receives liquid or fluid from fluid supply 16. Fluid receiver 14 includes needle 40, and valve assembly 42. Needle 40 comprises an elongate hollow tube, post, pin or column having walls 44 forming an interior 46 and a tip 48 having an opening 50. Interior 46 receives valve assembly 42 and terminates at tip 48. In the example illustrated, interior 46 is tapered proximate to opening 50. In other embodiments, interior 46 may not be tapered proximate to opening 50, but may have a floor extending substantially perpendicular to side surfaces of interior 50.

Opening 50 comprise a passage or aperture at tip 48 which is sufficiently large to allow valve pin 34 to project into interior 46 of needle 40. Opening 50 is further sized to permit portions of valve assembly 42 to partially project through or completely project through opening 50. Opening 50 includes lips or edges 51. As shown in FIG. 1, edges 51 cooperate with the valve assembly 42 to seal or close opening 50.

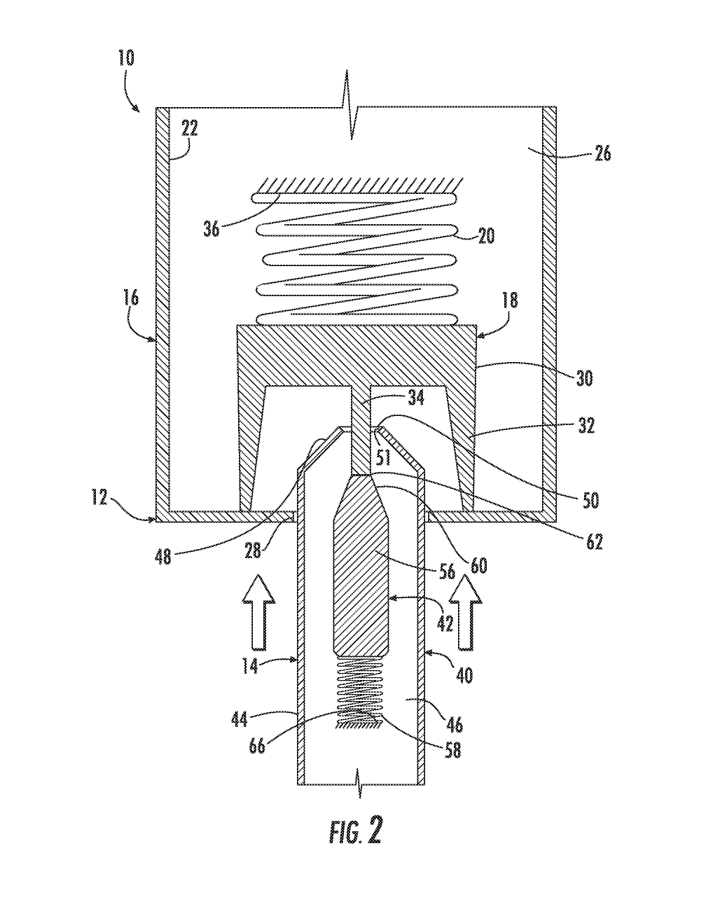

Valve assembly 42 is contained within interior 46 of needle 40 and is movable between a closed state (shown in FIG. 1) to an open state (shown in FIGS. 2 and 3) while engaging and moving valve stem 18 of fluid supply 12 from the closed state (shown in FIG. 1) to the open state (shown in FIG. 3). In the example illustrated, valve assembly 42 includes plunger 56 and bias 58. Plunger 56 comprises a member having a tapered end 60 and an abutment surface 62. Tapered end 60 is configured to at least partially project through opening 50 and to abut and seal against edges 51 of opening 50 when valve assembly 42 is in the closed state shown in FIG. 1. In one embodiment, tapered end 60 has an exterior frusto-conical surface. In other embodiments, tapered end 60 may have other tapering configurations.

Abutment surface 62 extends at an axial end of plunger 56 generally along an axial centerline of plunger 56. In the example illustrated, abutment surface 62 extends substantially perpendicular to the axial centerline of plunger 56. Abutment surface 62 is configured to contact, engage and apply force to, as well as receive force from, pin 34 of valve stem 18.

Bias 58 comprises a member or structure configured to resiliently bias plunger 56 towards the closed position or state shown in FIG. 1. In the example illustrated, bias 58 comprises a compression spring captured between plunger 56 and an opposite stationary or grounding surface 66. In the example illustrated, bias 58 has a spring constant less than the spring constant of bias 20. In other words, bias 58 is configured to be more easily compressed as compared to bias 20. In other embodiments, bias 58 have other configurations or maybe operably coupled to plunger 56 in other manners.

FIGS. 2 and 3 illustrate connection of fluid supply 12 and fluid receiver 14. As shown by FIG. 2, to initiate the connection between fluid supply 12 and fluid receiver 14, needle 40 is initially inserted through opening 28 of container 16 until abutment surface 62 contacts valve pin 34. Continued insertion of needle 40 through opening 28 moves or forces tapered surface 60 of plunger 56 out of engagement and away from edges 51 of opening 50 against the force of bias 58 such that bias 58 is compressed. As a result, valve assembly 42 is actuated or moved to the open state in which opening 50 is not closed. Although bias 58 applies a force to valve stem 18 which is transmitted to bias 20, because bias 20 has a greater spring constant as compared to bias 58, bias 20 does not sufficiently compress to withdraw blade 32 out of sealing engagement with container 16. Valve stem 18 initially remains in the closed position.

As shown by FIG. 3, further continued insertion of needle 40 through opening 28 results in bias 20 being compressed to an extent such that blades 32 are withdrawn from and moved out of sealing engagement with container 16. As a result, a flow passage is established from the interior of container 16, between valve stem 18 and container 16 and through opening 50 to fluid receiver 14 as indicated by arrow 70. This flow passage is established in a sequential step-wise manner in which opening 50 of fluid receiver 14 first opens while access to liquid within container 16 is still blocked by valve stem 18. Later, upon further insertion of needle 14, flow passage and completed by the movement of valve stem 18 to an open state. This sequential step-wise establishment of the flow passage reduces leakage during the connection of fluid supply 12 to fluid receiver 14.

As noted above, tapered end 60 of plunger 56 engages and seals against edges 51 of opening 50. Each time that plunger 56 moves from the open state (shown in FIGS. 2 and 3) to the closed state (shown in FIG. 1), edges 50 substantially contact the same identical opposite surface of tapered end 60. Any deformations or grooving formed over time in the surface of tapered end 62 as a result of its engagement with edges 51 over time will remain substantially opposite to the same portion of edges 51 that formed the deformation or groove. Despite the formation of deformations or grooving in tapered end 62 over time, plunger 56 will continue to provide a reliable seal of opening 50. This in contrast to the use of a ball in place of plunger 56. Because such a ball may rotate relative to opening 50, any deformations or groove formed in the ball over time may not exactly align with the opposing surface of edge 51 that formed the deformations or groove. This may result in a less than perfect seal and leakage.

Because such deformations or grooving do not substantially impair the ability of plunger 56 to seal opening 50, tapered end 60 of plunger 56 may be formed from a softer or more compressible material, increasing manufacturing tolerances for opening 50 and tapered end 60, enhancing the sealing effectiveness of tapered end 60 and reducing fabrication cost. In one embodiment, tapered end 60 has a surface formed from a material having a hardness of between 40 and 70 durometer. Examples of materials from which the surface of tapered end may be formed include, but are not limited to, SANTOPRENE (a mixture of EPDM and polypropylene) and ethelyne propylene diene M-class (EPDM). In other embodiments, tapered end 60 may be formed from other materials having other degrees of hardness. In yet other embodiments, tapered end 60 of plunger 56 may alternatively be configured to seal against interior surfaces of needle 40 at tip 48. In yet other embodiments, other structures may be used in lieu of plunger 56.

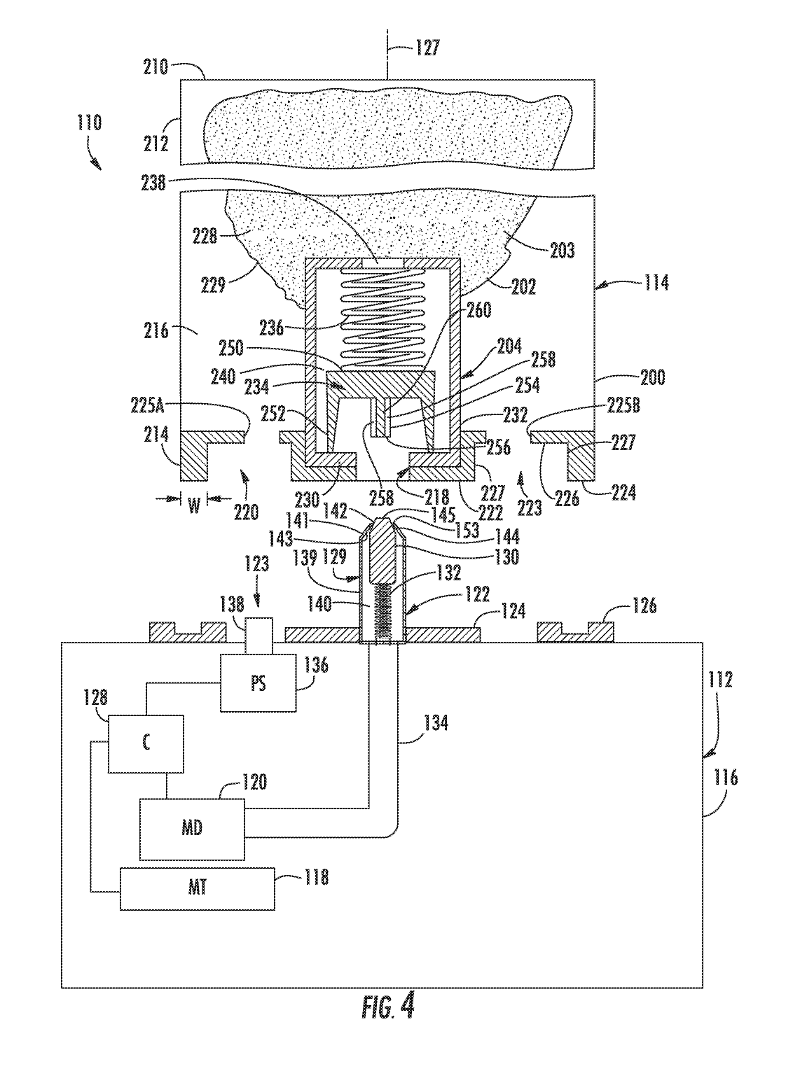

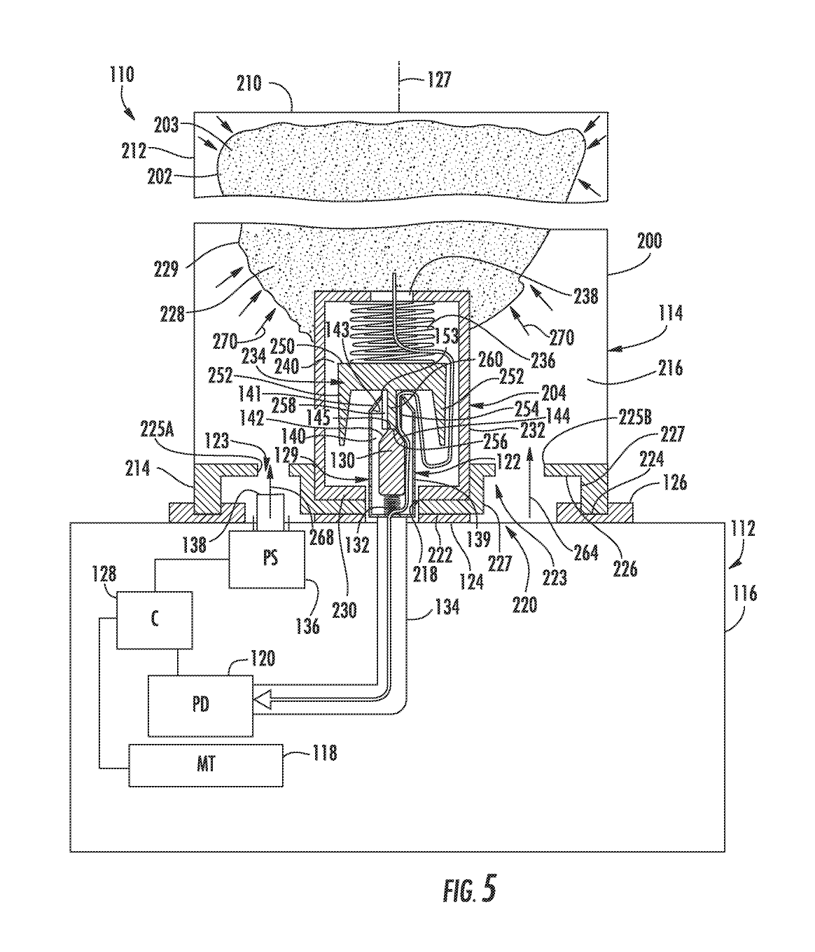

FIGS. 4 and 5 schematically illustrate fluid handling system 110, another embodiment of fluid handling system 10. System 110 includes a fluid receiver 112 and a fluid supply 114. FIG. 4 illustrates fluid receiver 112 and fluid supply 114 in disconnected states. FIG. 5 illustrates fluid receiver 112 and fluid supply 114 connected to one another.

Fluid receiver 122 comprises a device configured to receive and consume fluid. In the example illustrated, fluid receiver 112 comprises a printing mechanism or printer. In other embodiments, fluid receiver 112 may comprise other devices that consume fluid in use. Fluid receiver 112 includes housing 116, media transport 118, marking device 120, fluid interface 122, pressurization system 123, seals 124, 126 and controller 128.

Housing 116 comprises a frame, enclosure or other structures configured to support and contain the remaining components of fluid receiver 112. In one embodiment, housing 116 includes a cavity, recess or depression configured to receive or otherwise mate with fluid supply 114. In other embodiments, housing 116 may have other configurations.

Media transport 118 comprises a mechanism configured to transport or move print media relative to marking device 120. In one embodiment, media transport 128 may be configured to transport individual sheets of print media relative to marking device 120. In still other embodiments, media transport 118 may be configured to transport a substantially continuous web of media to be printed upon by marking device 120. Media transport 118 may utilize rollers, belts, conveyors, one or more drums or other mechanism for transporting such media.

Marking device 120 comprises a device configured to deposit fluid upon media supported by media transport 118. In one embodiment, marking device 120 may comprise one or more drop-on-demand inkjet print heads. Examples of such print heads include thermal inkjet print heads and piezoelectric inkjet print heads. In one embodiment, marking device 120 may scan or reciprocate such print heads back and forth across the media being printed upon. In another embodiment, marking device 120 may extend substantially across a dimension of the media being printed upon, such as with a page-wide-array print device. In yet other embodiments, marking device 120 may comprise other devices which deposit fluid onto a printable substrate. For purposes of this disclosure, a printable substrate or print media is any sheet or web of material upon which a liquid or solution (sometimes referred to as a marking fluid) may be patterned, ejected or otherwise deposited. Such a substrate may comprise a cellulose based material, such as paper, a polymeric based material or other materials such as metals.

In one embodiment, marking device 120 may be configured to deposit one more colors of fluid ink onto the media being printed upon. In yet other embodiments, marking device 120 may be configured to selectively deposit or apply other fluids upon a media or other substrate provided by media transport 118. In embodiments where fluid receiving device 112 does not comprise a printing mechanism, media transport 118 and marking device 120 may be omitted.

Fluid interface 122 comprises an arrangement of structures or components configured to receive and transmit fluid from fluid supply 114 to marking device 120. Fluid interface 122 includes needle 129, plunger 130, bias 132, fluid passage 134, pressure source 136 and pressure interface 138. Needle 129 comprises an elongate hollow tube, post, pin or column having walls 139 forming an interior 140 and a tip 141 having an opening 142. Interior 140 receives plunger 130 and terminates at tip 141.

Opening 142 comprises a passage or aperture at tip 141 which is sufficiently large to permit portions of fluid supply 114 to be inserted therethrough. Opening 142 is further sized to permit portions of plunger 130 to partially project through or completely project through opening 142. Opening 142 includes lips or edges 143. As shown in FIG. 1, edges 143 cooperate with plunger 130 to seal or close opening 142.

Because opening 142 is an axial opening on an end of needle 129, as compared to a side opening, a fluid connection between the receiver 112 and supply 114 may be achieved in a more compact and less space consuming manner. In particular, the “end” opening 142 reduces an extent to which needle 129 must be inserted into fluid supply 114. In addition, as compared to a side opening, the “end” opening 142 is more robust with respect to tolerance variability. In other embodiments, needle 129 may include one or more openings or one or more ports at other locations.

Plunger 130 is contained within interior 140 of needle 129 and is movable between a closed state (shown in FIG. 4) to an open state (shown in FIG. 5) while actuating fluid supply 114 from the closed state (shown in FIG. 4) to the open state (shown in FIG. 5). Plunger 130 comprises a member having a tapered end 144 and an abutment surface 145. Tapered end 144 is configured to at least partially project through opening 142 and to abut and seal against edges 143 of opening 142 when plunger 130 is in the closed state shown in FIG. 4. In one embodiment, tapered end 144 has an exterior frusto-conical surface. In other embodiments, tapered end 144 may have other tapering configurations.

Abutment surface 145 extends at an axial end of plunger 130 generally along an axial centerline of plunger 130. In the example illustrated, abutment surface 145 extends substantially perpendicular to the axial centerline of plunger 130. Abutment surface 145 is configured to contact, engage and apply force to, as well as receive force from, stem 234 of fluid supply 114.

Bias 132 comprises a mechanism configured to resiliently bias plunger 130 towards the closing state or sealing position. In the example illustrated, bias 132 comprises a compression spring captured within the interior 140 of needle 129 and urging plunger 130 into a seated, sealing position across opening 143. In other embodiments, bias 132 may comprise other structures.

Fluid passage 134 comprises a fluid conduit extending from interior 140 of needle 129 to marking device 120. In one embodiment, fluid passage 134 may comprise a flexible tube. In other embodiments, fluid passage 134 may comprise a rigid fluid pipe. Fluid passage 134 may have a variety of different shapes and configurations.

Pressurization system 123 pressurizes the interior 216 of container 200 adjacent the exterior 224 of bag 202 to assist in expelling fluid from fluid supply 114. Pressurization system 123 includes pressure source 136 and pressure interface 138. Pressure source 136 comprises a source of pressurized fluid, such as a pressurized gas or pressurized liquid. Pressure source 136 is configured to deliver such pressurized fluid through interface 138 into an interior of fluid supply 114 to assist in expelling fluid from fluid supply 114.

Seal 124 comprises a structure extending about fluid interface 122 that is configured to seal between fluid receiver 112 and fluid supply 114 about fluid interface 122 when fluid receiver 112 is connected to fluid supply 114. In the example illustrated, seal 124 comprises an annular ring of compressible or rubber-like material, which when pressed against opposite sealing surfaces of fluid supply 114 forms a pneumatic seal.

Seal 126 comprises one or more structures extending about pressure interface 138 that are configured to seal between fluid receiver 112 and fluid supply 114 about pressure interface 138. In the example illustrated, seal 126 comprises an annular cup-shaped compressible structure configured to not only abut, but also partially wrap about opposite sealing surfaces of fluid supply 114. Because seal 126 is cup-shaped, seal 126 provides a more reliable seal against fluid supply 114 while at the same time allowing easier and less complex disconnection of supply 114 from receiver 112. For example, in one embodiment, fluid supply 114 may be moved in a direction along the center line 127 of fluid supply 114 to withdraw fluid supply 114 from fluid receiver 112. Because seal 126 is annular, fluid supply 114 may be rotated about its centerline 127 during connection or disconnection of fluid supply 114 and fluid receiver 112. In other embodiments, seal 126 may have other configurations.

Controller 128 comprises one or more processing units configured to generate control signals directing the operation of media transport 118, marking device 120 and pressure source 136 (when provided). Controller 128 generates such control signals to control the deposition of fluid on media transported by media transport 118. Controller 128 further controls the supply of pressurized fluid by pressure source 136 to at least partially control the rate at which fluid is expelled from fluid supply 114 and received by fluid supply 112.

For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, controller 128 may be embodied as part of one or more application-specific integrated circuits (ASICs). Unless otherwise specifically noted, the controller is not limited to any specific combination of hardware circuitry and software, nor to any particular source for the instructions executed by the processing unit.

Fluid supply 114 supplies the consumable fluid to fluid receiver 112. Fluid supply 114 includes container 200, bag 202, fluid 203 and valve assembly 204. Container 200 comprises a substantially imperforate vessel configured to contain and enclose bag 202 and valve assembly 204. Container 200 allows fluid or gas to be injected into container 200 about or around bag 202 to force or expel fluid from bag 202. Container 200 includes bottom 210, annular sidewall 212 and cap 214. For purposes of this disclosure, the term “annular” encompasses both circular and non-circular rings. Bottom 210, sidewall 212 and cap 214 cooperate to form or define an interior 216 configured to contain bag 202 and valve assembly 204. In one embodiment, bottom 210 and cap 214 are substantially circular while sidewall 212 is substantially cylindrical. In other embodiments, bottom 210, cap 214 and sidewall 212 may have other shapes, such as polygonal shapes.

As schematically shown by FIG. 4, cap 214 comprises a one-piece cap integrally formed as a single unitary body. Cap 214 is joined to a remainder of container 200. In the example illustrated, cap 214 is fixedly sealed to container 200. For example, one embodiment, cap 214 is permanently welded to side wall of container 200. Cap 214 includes fluid interfaces 218 and 220. Because cap 214 comprises a single unitary body one piece structure that provides both fluid interfaces 218 and 220, cap 214 reduces assembly time and cost for fluid supply 114. In addition, cap 214 has fewer parts in that it may omit multiple gaskets, O-rings and the like which might otherwise have to be provided, increasing costs and assembly complexity. Moreover, because cap 214 comprises a one-piece cap or a one-piece structure, precise control of the relative positioning of fluid interfaces 218 and 220 may be achieved during molding or other fabrication of cap 214, reducing tolerance stack. Such control over the relative positioning of fluid interfaces 218 and 220 better assures more reliable connection of the interfaces 218, 220 with corresponding interfaces of fluid receiver 112.

Fluid interface 218 is configured to permit fluid to be injected into or expelled from an interior of bag 202. In the example illustrated, fluid interface 218 comprises an opening in fluid communication with an interior of valve assembly 204. The opening of interface 218 is sized and shaped so as to receive needle 129 of fluid receiver 112. The opening of fluid interface 218 facilitates fluid flow from bag 202 through needle 129 into fluid receiver 112. In particular circumstances, the opening of fluid interface 218 may also be utilized to allow fluid to be supplied into bag 202. Fluid interface 218 is substantially aligned with a centerline or central axis 127 of container 200. Although fluid interface 218 is illustrated as comprising an opening, serving as a female feature which receives a male feature (needle 129 of a corresponding fluid receiver interface), in other embodiments fluid interface 218 may alternatively comprise a male feature, wherein the fluid interface associated with the fluid receiver comprises a female fluid interface.

Pressure interface 220 comprises an interface configured to cooperate with interface 122 of fluid receiver 112 such that air or other gas may be injected into container 200 between container 200 and an exterior 224 of bag 202. At the same time, pressure interface 220 facilitates more precise, accurate and reliable connection of fluid supply 114 to fluid receiver 112. Pressure interface 220 includes center portion 222, channel 223, outer rim 224 and openings 225A, 225B (collectively referred to as openings 225).

Center portion 222 comprises that portion of cap 214 extending about the opening of fluid interface 218 and centered about centerline 127. Center portion 222 extends generally opposite to seal 124 when fluid supply 114 is connected to fluid receiver 112. Center portion 222 comprises a hub or platform that provides a sealing surface against which seal 124 abuts to form a pneumatic seal between the opening of fluid interface 218 and channel 223 of fluid interface 220.

Channel 223 concentrically extends about center portion 222 and forms an annular groove or recess through which air or other gas may flow around center portion 222 to each of openings 225. In the example illustrated, channel 223 further provides a depression or cavity into which pressure interface 138 may extend when fluid supply 114 is connected to fluid receiver 112. In other embodiments, pressure interface 138 may alternatively not extend into channel 223. As shown by FIG. 4, channel 223 is defined by a floor 226 and a pair of opposing side walls 227. Because channel 223 concentrically extends about fluid interface 218, angular or rotation alignment of fluid interface 138 is less difficult. In particular, fluid interface 138 may be positioned opposite to or into any portion of channel 223 about fluid interface 218 while still allowing a pressurizing air or gas to be directed into interior 116 through openings 225.

Rim 224 comprises that portion of cap 214 extending outward of channel 223. Rim 224 provides a sealing surface against which seal 126 may abut to form a pneumatic seal about and outside of channel 223. In the example illustrated, rim 224 has a radial width W such that rim 224 may be received within seal 126, allowing seal 126 to wrap about three sides of rim 224 for an enhanced pneumatic seal. Because rim 224 concentrically extends about fluid interface 218, connection of fluid interface 122 and fluid interface 218 also serves to align rim 224 with respect to seal 126 for an enhanced pneumatic seal.

Openings 225 comprise apertures extending through floor 226 to interior 216 of container 200. In the example illustrated, openings 225 comprise two diametrically opposed apertures on opposite sides of fluid interface 218. As a result, air or other pressurized gas may flow through openings 225 into interior 216 on opposite side of bag 202 for more uniform and dispersed application of pressure to bag 202 to expel fluid from bag 202. In effect, bag 202 is squeezed from opposite sides for more reliable expulsion of fluid. Although fluid interface 220 is illustrated as including two diametrically opposed openings 225, in other embodiments, fluid interface 220 may include greater than two apertures or openings 225 spaced along channel 223 through floor 226.

Bag 202 comprises a flaccid, flexible or collapsible vessel or film configured to contain fluid 203 and to separate or isolate fluid 203 from container 200 within interior 216. Bag 202 has an interior 228 and an exterior 229. Interior 228 is fluidly coupled to or in fluid communication with an interior of valve assembly 204. Likewise, interior 228 is fluidly coupled to opening 218 when valve assembly 204 is in an open state. For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members. The term “fluidly coupled” shall mean that two are more fluid transmitting volumes are connected directly to one another or are connected to one another by intermediate volumes or spaces such that fluid may flow from one volume into the other volume.

Bag 202 is formed from one or more materials configured to contain fluid 203 while substantially inhibiting permeation of air, fluid or other gases through the walls of bag 202 into the fluid 203 within bag 202. In some embodiments, bag 202 is configured to contain fluid 103 while maintaining fluid 203 in a substantially degassed state

Fluid 203 comprises a fluid utilized by fluid receiver 112. In one embodiment, fluid 203 comprises a liquid. In one embodiment where fluid receiver 112 comprises a printing mechanism or system or device, fluid 203 comprises a printing liquid or solution (also known as a marking fluid). In embodiments where text, graphics or other images are to be printed upon a medium, fluid 203 may comprise an ink. For example, fluid 203 may comprise a black ink or one of various colors of ink. In yet another embodiment, fluid 203 may comprise other liquid solutions carrying solutes which are to be patterned upon a substrate by a fluid ejection device.

Valve assembly 204 comprises an assembly or mechanism configured to control the flow of fluid into and/out of interior 222 of bag 202 within container 200. Valve assembly 204 is further configured to interface with needle 129 of fluid receiver 112 to transmit fluid through needle 129 into receiver 112. Moreover, at substantially the same time that valve assembly 204 is actuated to an open state due to its interaction with needle 129, valve assembly 204 substantially concurrently actuates plunger 130 to open state or open position. Consequently, valves of both receiver 112 and supply 114 are concurrently opened to facilitate fluid flow therebetween. Upon disconnection, the valves of both receiver 112 and supply 114 are automatically closed to retain existing fluid within receiver 112 and supply 114 while also inhibiting the drying of such existing fluid. As a result, dried fluid is less likely to occlude fluid passages or interiors of fluid receiver 112 or fluid supply 114.

As shown by FIG. 4, valve assembly 204 includes fluid seal 230, valve body 232, valve stem 234 and bias 236. Fluid seal 230 comprises a gasket, ring or other structure of compressible material extending about opening 218 within an interior 216 of container 200. Fluid seal 230 is configured to cooperate with valve stem 234 to close opening 218 when valve stem 234 is in a closed state. Although seal 230 is disclosed as being compressible, elastomeric or rubber-like while those portions of valve stem 234 that contact seal 230 are substantially rigid, in other embodiments, this relationship may be reversed where seal 230 comprises an annular rigid blade-like member and valve stem 234 includes an elastomeric, compressible, rubber-like mating and sealing structure.

Valve body 232 comprises one or more structures configured to contain the remaining components of valve assembly 204 proximate to opening 218 of container 200. Valve body 232 is substantially imperforate and extends about opening 218 within interior 216 of container 200. Valve body 232 includes a port 238 fluidly connecting interior 228 of bag 202 to an interior 240 of body 232. Port 238 allows fluid 203 to enter interior 240 of body 232.

Valve stem 234 comprises a structure within valve body 232 configured to control the flow of fluid through valve body 232 and to also actuate plunger 130 of fluid receiver 112. Valve stem 234 projects into needle 129 during reception of needle 129 by opening 218 and by valve body 232. Valve stem 234 includes base 250, annular blade 252 and pin 254. Base 250 supports blade 252 and pin 254. Blade 252 projects from base 250 and is configured to contact and sealingly engage with seal 230 when valve stem 234 is moved to a sealing position as shown in FIG. 4. Blade 252 completely extends around pin 254 and completely closes off opening 218 when valve stem 234 is in the sealing position shown.

Pin 254 projects from base 250 and is surrounded by blades 252. Pin 254 is configured to project into interior 140 of needle 129 when needle 129 is inserted through opening 118 into body 232 where it is surrounded by blade 252. Pin 254 is further configured to contact plunger 130 to move plunger 130 against bias 132 from a sealing or closed state or position to an open state or position. In the example illustrated, pin 254 has an axial end or head 256 configured to contact or abut plunger 130 during connection of fluid supply 114 with fluid receiver 112.

In the example illustrated, pin 254 includes flow passages 258 at least partially along its axial length. Flow passages 258 facilitate insertion of pin 254 into interior 140 of needle 129 against plunger 130 and bias 132 while providing a passage through which fluid may flow from the interior 240 of valve body 232 and from bag 202 into interior 140 of needle 129. In one embodiment, flow paths 258 extend along the sides of pin 254. In one embodiment, flow paths 258 are formed by castellations 260 circumferentially spaced about and axially extending along pin 254. In other embodiments, flow paths 258 may be provided at other locations along or through pin 254.

Bias 236 comprises one or more members configured to resiliently urge or bias valve stem 234 towards the closing or sealed position shown in FIG. 4. In the example illustrated, bias 236 comprises a compression spring captured between base 250 of valve stem 234 and valve body 232. The spring of bias 236 has a spring constant such that engagement of needle 129 with valve stem 234 or engagement of plunger 130 with pin 254 will result in compression of bias 236 and movement of valve stem 234 towards bottom 210 to an open position. At the same time, the spring constant of bias 132 with respect to the spring constant of bias 236 is such that engagement of pin 254 against plunger 130 results in compression of bias 132 and movement of plunger 130 to an open state. In other embodiments, bias 236 may have other configurations.

FIG. 5 illustrates system 110 with fluid supply 114 connected to fluid receiver 112. FIG. 5 illustrates the supply of fluid to receiver 112. As shown by FIG. 5, fluid supply 114 is brought into mating, interlocking or coupled relationship with respect to fluid receiver 112. As a result, interface 138 is received through opening 220 to provide communication between pressure source 136 and interior 216 of container 200. This also results in needle 129 being inserted through opening 218. During such insertion of needle 129 through opening 218, seal 230 seals against sides of needle 129. At the same time, pin 254 exerts a force upon plunger 130 to compress bias 132 so as to open opening 142 (shown in FIG. 4) of needle 129. Plunger 130 and bias 132 also exert force upon pin 254 so as to move valve stem 234 against bias 236 to the open position. As a result, as indicated by arrow 264, a fluid passage is formed from the interior 222 of bag 202 through opening 238 into valve body 232, along flow passages 258 into interior 140 of needle 129 and through fluid passage 134 to marking device 120 (or other fluid consuming devices of receiver 112).

In response to entry of commands from a user or external electronic device or in response to signals from one or more sensors indicating proper connection of fluid supply 114 to receiver 112, controller 128 generates control signals correcting pressure source 136 to supply pressurized fluid to the interior 216 of container 200 as indicated by arrow 268. As indicated by arrows 270, the pressurization of interior 216 exerts a force against exterior 224 of bag 202 to compress or squeeze fluid 203 out of bag 202 and along the aforementioned fluid path. Upon a sufficient volume or amount of fluid being transferred to fluid receiver 112, fluid supply 114 may be disconnected from fluid receiver 112. In response to such disconnection, bias 132 automatically returns plunger 130 to the closed position shown in FIG. 4 and bias 236 automatically returns the valve stem 234 to the closed position shown in FIG. 4.

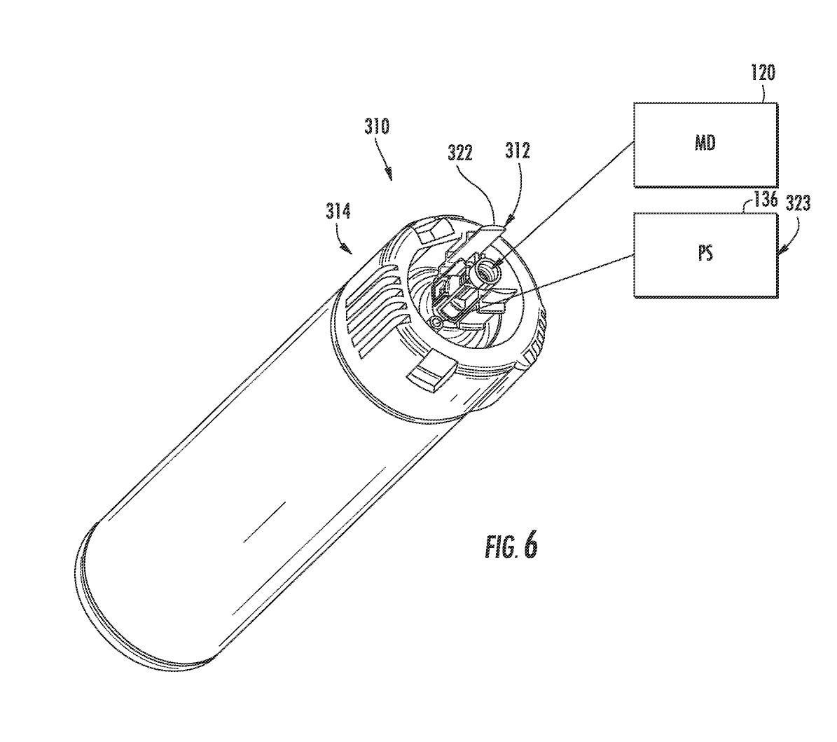

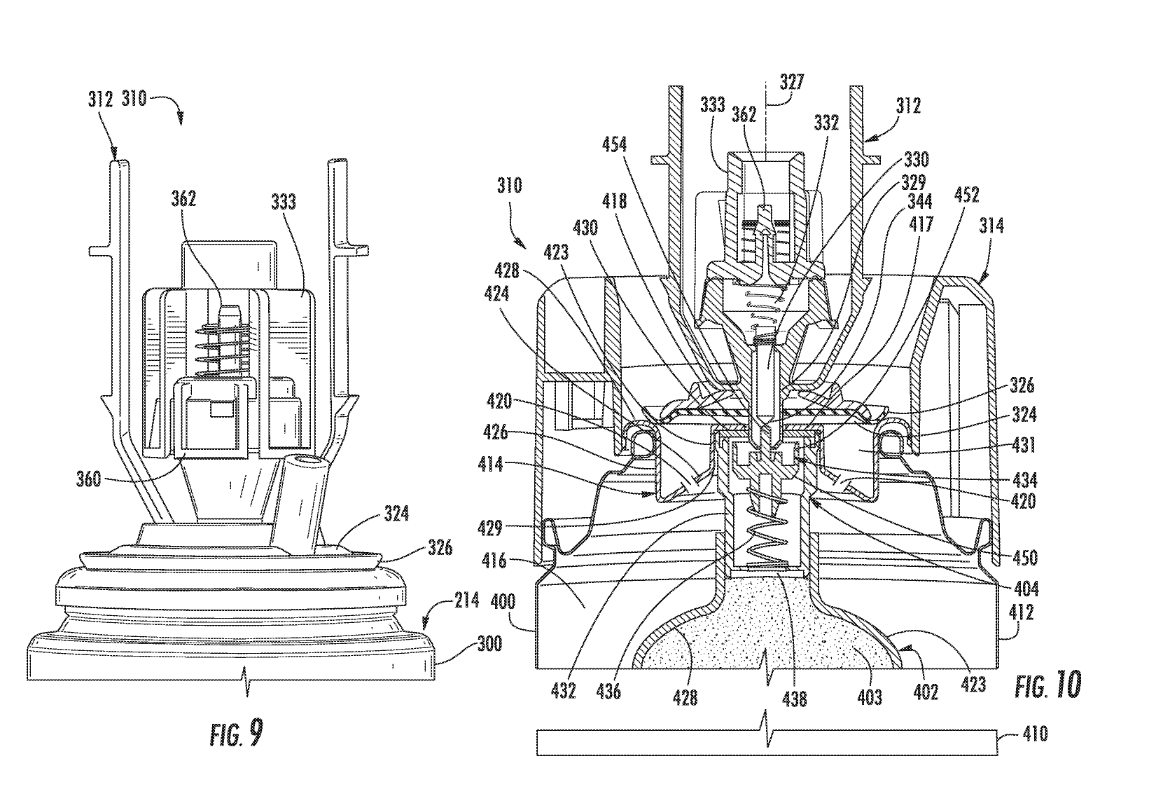

FIGS. 6-11 illustrate fluid handling system 310, another embodiment of system 10 shown in FIGS. 1-3. System 310 is similar to system 10 in that system 310 provides a compact arrangement of features for connecting a fluid supply to fluid receiver while facilitating reliable fluid seals for both the fluid supply and the fluid receiver to inhibit drying of fluid within the fluid passages of the supply and the receiver. As with system 10, system 310 includes a fluid receiver 312 (shown separately in FIGS. 4 and 5) and a fluid supply 314 (shown in FIGS. 6, 9 and 10).

Fluid receiver 312 comprises a device configured to receive and consume fluid. In the example illustrated, fluid receiver 312 comprises a printing mechanism or printer. In other embodiments, fluid receiver 312 may comprise other devices that consume fluid in use. Fluid receiver 312 includes housing 116, media transport 118, marking device 120 and controller 128, each of which is shown and described above with respect to FIG. 4. Fluid receiver 312 additionally includes fluid interface 322, pressurization system 323 and seals 324, 326 in place of fluid interface 122, pressurization system 136 and seals 124, 126, respectively.

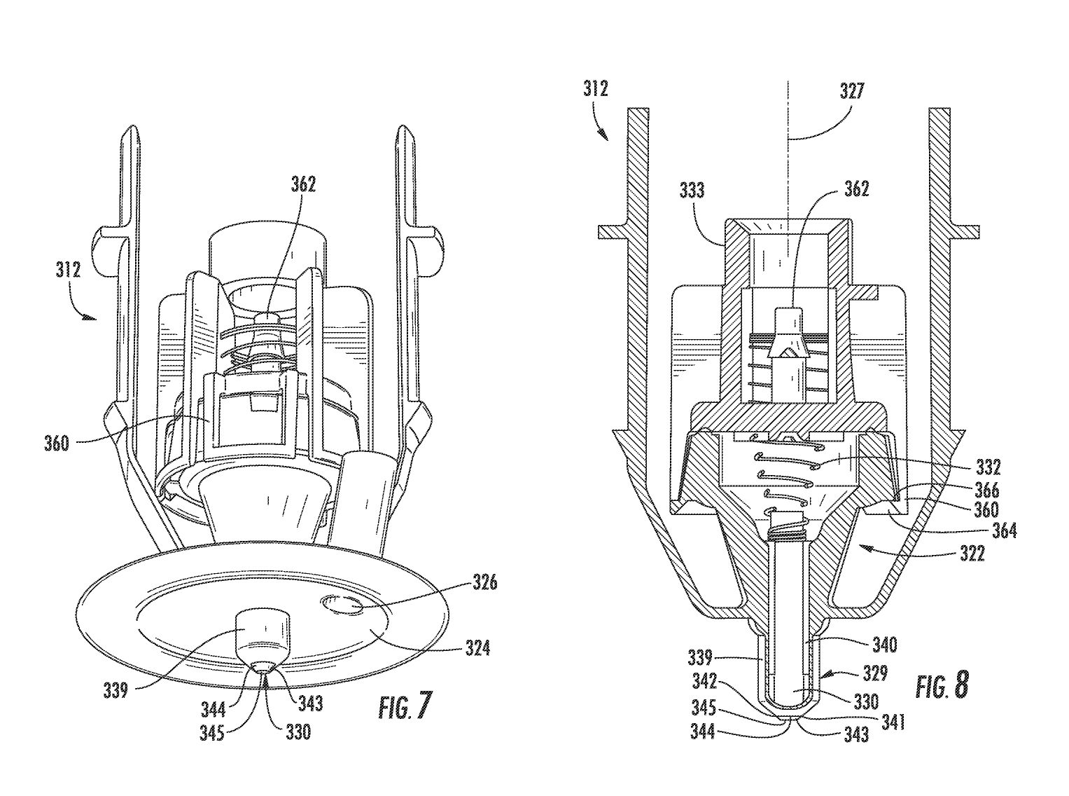

Fluid interface 322 comprises an arrangement of structures or components configured to receive and transmit fluid from fluid supply 314 to marking device 120. In the example illustrated, fluid interface 322 is further configured to assist in expelling fluid from fluid supply 314. As shown by FIGS. 7 and 8, fluid interface 322 includes needle 329, plunger 330, bias 332 and valve retainer 333.

Needle 329 comprises an elongate hollow tube, post, pin or column having walls 339 forming an interior 340 and a tip 341 having an opening 342. Interior 340 receives plunger 330 and terminates at tip 341.

Opening 342 comprises a passage or aperture at tip 341 which is sufficiently large to receive portions of fluid supply 314. Opening 342 is further sized to permit portions of plunger 330 to partially project through or completely project through opening 342. Opening 342 includes lips or edges 343. As shown in FIGS. 7 and 8, edges 343 cooperate with plunger 330 to seal or close opening 342.

Because opening 342 is an axial opening on an end of needle 329, as compared to a side opening, a fluid connection between the receiver 312 and supply 314 may be achieved in a more compact and less space consuming manner. In particular, the “end” opening 342 reduces an extent to which needle 329 must be inserted into fluid supply 314. In addition, as compared to a side opening, the “end” opening 342 is more robust with respect to tolerance variability. In other embodiments, needle 329 may include one or more openings or one or more ports at other locations.

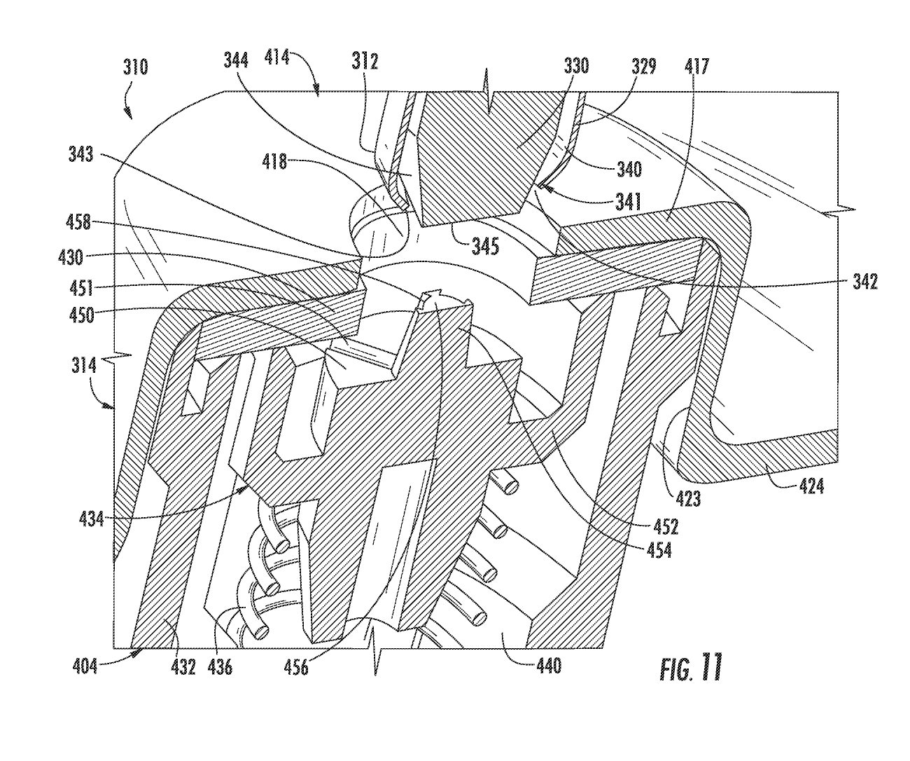

Plunger 330 is contained within interior 340 of needle 329 and is movable between a closed state (shown in FIG. 4) to an open state (shown in FIG. 5) while actuating fluid supply 114 from the closed state (shown in FIGS. 7, 8 and 11) to the open state (shown in FIG. 10). Plunger 330 comprises a member having a tapered end 344 and an abutment surface 345. Tapered end 344 is configured to at least partially project through opening 342 and to abut and seal against edges 343 of opening 342 when plunger 330 is in the closed state. In one embodiment, tapered end 344 has an exterior frusto-conical surface. In other embodiments, tapered end 344 may have other tapering configurations.

Abutment surface 345 extends at an axial end of plunger 330 generally along an axial centerline of plunger 330. In the example illustrated, abutment surface 345 extends substantially perpendicular to the axial centerline of plunger 330. Abutment surface 345 is configured to contact, engage and apply force to, as well as receive force from, pin 354 of fluid supply 314.

Bias 332 comprises a mechanism configured to resiliently bias plunger 330 towards the closing state or sealing position. In the example illustrated, bias 332 comprises a compression spring captured within the interior 340 of needle 329 and urging plunger 330 into a seated, sealing position across opening 343. In other embodiments, bias 332 may comprise other structures.

Valve retainer 333 comprises an end cap coupled to an upper end of needle 329 that is configured to capture and retain bias three 332 against plunger 330. In the example illustrated, valve retainer 333 includes snap tabs 360 and barbed fitting 362. As shown by FIG. 7, snap tabs 360 extend about the upper end of needle 329 and resiliently flex outwardly to snap onto the upper end of needle 329. As shown by FIG. 8, each snap tab 360 includes a hook 364 that extends under a corresponding shoulder 366 of needle 329. In other embodiments, this relationship may be reversed. Because valve retainer 333 snaps onto needle 329, valve retainer 329 may be easily removed to facilitate repair or placement of plunger 330 and bias 332.

Barbed fitting 362 comprises a barbed tube having a hollow interior or port, wherein the fitting 362 is configured to be inserted into a tube or hose. As a result, valve retainer 333 serves to facilitate connection of valve retainer 333 and needle 329 to a tube of fluid receiver 312. Valve retainer 333 serves multiple functions: retaining or capturing plunger 330 and bias 332 while facilitating connection of a tube to needle 329.

Pressurization system 323 pressurizes the interior 416 of container 400 adjacent the exterior 424 of bag 402 to assist in expelling fluid from fluid supply 314. Pressurization system 323 includes pressure source 136. Pressure source 136 comprises a source of pressurized fluid, such as a pressurized gas or pressurized liquid. Pressure source 136 is configured to deliver such pressurized fluid into an interior of fluid supply 314 to assist in expelling fluid from fluid supply 314.

Seal 324 comprises a structure extending about fluid interface 432 that is configured to seal between fluid receiver 312 and fluid supply 314 about fluid interface 322 when fluid receiver 312 is connected to fluid supply 314. In the example illustrated, seal 434 comprises an annular ring of compressible or rubber-like material, which when pressed against opposite sealing surfaces of fluid supply 314 to form a pneumatic seal.

Seal 326 comprises one or more structures extending about pressure interface 448 that is configured to seal between fluid receiver 312 and fluid supply 314 about pressure interface 448. In the example illustrated, seal 326 comprises a semi-cylindrical or curved annular lip of compressible structure configured to abut against opposite sealing surfaces of fluid supply 314. Because seal 326 is annular, fluid supply 314 may be rotated about its centerline 327 during connection or disconnection of fluid supply 314 and fluid receiver 312. In other embodiments, seal 326 may have other configurations.

Fluid supply 424 supplies the consumable fluid to fluid receiver 312. Fluid supply 314 includes container 400, bag 402, fluid 403 (schematically shown) and valve assembly 404. Container 400 comprises a substantially imperforate vessel configured to contain and enclose bag 402 and valve assembly 404. Container 400 allows fluid to be injected into container 400 around or about bag 402 to force or expel fluid from bag 402. Container 400 includes bottom 410, annular sidewall 412 and cap 414. In one embodiment, bottom 410 and cap 414 are substantially circular while sidewall 412 is substantially cylindrical. In other embodiments, bottom 410, cap 414 and sidewall 412 may have other shapes, such as polygonal shapes. As shown by FIG. 10, bottom 410, sidewall 412 and cap 414 cooperate to further define an interior 416 configured to contain bag 402 and valve assembly 404.

As shown by FIG. 10, cap 414 includes center portion 417, annular walls 423, floor portion 424, annular wall 426 and rim 428. Center portion 417 comprises a substantially planar plateau defining or forming opening 418. Opening 418 is in fluid communication with an interior of valve assembly 404. Opening 418 is sized and shaped so as to receive needle 329 of fluid receiver 312. Opening 418 facilitates fluid flow from bag 402 through needle 329 and to fluid receiver 312. In particular circumstances, opening 418 may also be utilized to allow fluid to be supplied into bag 402. In the example illustrated, opening 418 is substantially aligned with a centerline or central axis 327 of container 400. In other embodiments, opening 418 may be at other locations.

Wall 423 extends from center portion 417 towards a bottom 410. Wall 423 is substantially annular and cooperates with center portion 417 to form a cup-shaped central portion of cap 414 having a depression or cavity 429 which faces an interior of the container and which receives, retains and aligns a portion of valve assembly 404 with opening 418. Floor portion 424 extends outwardly from walls 422. Whereas wall 423 is substantially perpendicular with respect to center portion 417, floor portion 424 is substantially perpendicular or oblique with respect to wall 423. Floor portion 424 forms one or more openings 420.

Openings 420 comprise one or more apertures in fluid communication with or fluidly coupled to interior 416 of container 400 along an exterior of bag 402. Each opening 420 is configured to permit fluid, such as a liquid or a gas, to be injected into interior 416 so as to pressurize the interior 416 so as to expel fluid 403 through valve assembly 404 and opening 418. Openings 420 comprise apertures extending through floor 424 to interior 416 of container 400. In the example illustrated, openings 420 comprise two diametrically opposed apertures on opposite sides of valve assembly 404. As a result, air or other pressurized gas may flow through openings 420 into interior 416 on opposite side of bag 402 for more uniform and dispersed application of pressure to bag 402 to expel fluid from bag 402. In effect, bag 402 is squeezed from opposite sides for more reliable expulsion of fluid. Although cap 414 is illustrated as including two diametrically opposed openings 420, in other embodiments, cap 414 may include greater than two apertures or openings 420 spaced along floor 424. In the example illustrated, each opening 420 remains in an open state upon withdrawal of interface 432. In other embodiments, openings 420 may be provided with a septum, temporary seal or a valve mechanism so as to be in a closed state prior to initial connection to a fluid receiver 422 for the first time or each time that interface 322 is withdrawn from opening 418.

Wall 426 annually extends around opening 418 and extends from floor portion 424 away from bottom 410. Wall 426 along with floor portion 424 and wall 423 form an annular channel 431 extending about opening 418. Channel 423 concentrically extends about center portion 417 and forms an annular groove or recess through which air or other gas may flow around center portion 423 to each of openings 420. Because channel 431 concentrically extends about valve assembly 404, angular or rotational alignment of fluid interface 404 with fluid interface 322 is less difficult. In particular, fluid interface 322 may be positioned opposite to channel 431 about fluid interface 404 while still allowing a pressurizing air or gas to be directed into interior 416 through openings 420.

Rim 428 extends from wall 426 and wraps around a center portion of an intermediate wall 433 which is itself joined to sidewall 412 of container 400. In one embodiment, rim 428 is outwardly bent and crimped to a remainder of container 400. In other embodiments, rim 428 may be secured to the rest of container 400 in other fashions, such as by welding, bonding, mechanical interlocks and the like. In yet other embodiments, cap 414 may alternatively be integrally formed as part of a single unitary body with at least portions of a remainder of container 400.

Bag 402 comprises a flaccid, flexible or collapsible vessel or film configured to contain fluid 403 and to separate or isolate fluid 403 from container 400 within interior 416. Bag 402 has an interior 422 and an exterior 424. Interior 422 is fluidly coupled to or in fluid communication with an interior of valve assembly 404. Likewise, interior 422 is fluidly coupled to opening 418 when valve assembly 404 is in an open state. Bag 402 is formed from one or more materials configured to contain fluid 403 while substantially inhibiting permeation of air, fluid or other gases through the walls of bag 402 into the fluid 403 within bag 402.

Fluid 403 comprises a fluid utilized by fluid receiver 312. In one embodiment, fluid 403 comprises a liquid. In one embodiment where fluid receiver 312 comprises a printing mechanism, fluid 403 comprises a printing fluid or marking fluid. In embodiments where text, graphics or other images are to be printed upon a medium, fluid 403 may comprise a fluid ink. For example, fluid 403 may comprise a black ink are one of various colors of ink. In yet another embodiment, fluid 403 may comprise other liquid solutions carrying solutes which are to be patterned upon a substrate.

Valve assembly 404 comprises an assembly or mechanism configured to control the flow of fluid into and out of interior 428 of bag 402 within container 400. Valve assembly 404 is further configured to interface with needle 329 of fluid receiver 312 to transmit fluid through needle 329 into receiver 312. Moreover, at substantially the same time that valve assembly 404 is actuated to an open state due to its interaction with needle 329, valve assembly 404 substantially concurrently actuates plunger 330 to an open state or position. Consequently, valves of both receiver 312 and supply 314 are concurrently opened to facilitate fluid flow therebetween. Upon disconnection, the valves of both receiver 312 and supply 314 are concurrently closed to retain existing fluid within receiver 312 and supply 314 while also inhibiting the drying of such existing fluid. As a result, dried fluid is less likely to occlude fluid passages or interiors of fluid receiver 312 or fluid supply 314.

As shown by FIG. 10, valve assembly 404 includes fluid seal 430, valve body 432, valve stem 434 and bias 436. Fluid seal 430 comprises a gasket, ring or other structure of compressible material extending about opening 418 within an interior 416 of container 400. Fluid seal 430 is configured to cooperate with valve stem 434 to close opening 418 when valve stem 434 is in a closed state. Although seal 430 is disclosed as being compressible, elastomeric or rubber-like while those portions of valve stem 434 that contact seal 430 are substantially rigid, in other embodiments, this relationship may be reversed where seal 430 comprises an annular rigid blade-like member and valve stem 434 includes an elastomeric, compressible, rubber-like mating and sealing structures.

Valve body 432 comprises one or more structures configured to contain the remaining components of valve assembly 404 proximate to opening 418 of container 400. Valve body 432 is substantially imperforate and extends about opening 418 within interior 416 of container 400. Valve body 432 includes a port 438 fluidly connecting interior 422 of bag 402 to an interior 440 of body 432 (shown in FIG. 11). Port 438 allows fluid 403 to enter interior 440 of body 432.

Valve stem 434 comprises a structure within valve body 432 configured to control the flow of fluid through valve body 432 and to also actuate plunger 330 of fluid receiver 312. Valve stem 434 projects into needle 329 during reception of needle 329 by opening 418 and by valve body 432. Valve stem 434 includes base 450, annular blade 452 and pin 454. Base 450 supports blade 452 and pin 454. Blade 452 projects from base 450 and is configured to contact and sealingly engage with seal 430 when valve stem 434 is moved to a sealing position as shown in FIG. 11. Blade 452 completely extends around pin 454 and completely closes off opening 418 when valve stem 434 is in the sealing position shown.

Pin 454 projects from base 450 and is surrounded by blades 452. Pin 454 is configured to project into interior 340 of needle 329 when needle 329 is inserted through opening 418 into body 432 where it is surrounded by blade 452. Pin 454 is further configured to contact plunger 330 to move plunger 330 against bias 332 from a sealing or closed state or position to an open state or position. In the example illustrated, pin 454 has an axial end or head 456 configured to contact in plunger 330 during connection of fluid supply 314 with fluid receiver 312.

As shown by FIG. 11, in the example illustrated, pin 454 includes flow passages 458 at least partially along its axial length. Flow passages 458 facilitate insertion of pin 454 into interior 340 of needle 329 against plunger 330 and bias 332 while providing a passage through which fluid may flow from the interior 440 of valve body 432 and from bag 402 into interior 340 of needle 329. In one embodiment, flow paths 458 extend along the sides of pin 454. In one embodiment, flow paths 458 are formed by castellations 460 encircling pin 454. In other embodiments, flow paths 458 may be provided at other locations along or through pin 454.

Bias 436 comprises one or more members configured to resiliently urge or bias valve stem 434 towards the closing or sealed position shown in FIGS. 7 and 8. In the example illustrated, bias 436 comprises a compression spring captured between base 450 of valve stem 434 and valve body 432. The spring of bias 436 has a spring constant such that engagement of needle 329 with valve stem 434 or engagement of plunger 330 with pin 454 will result in compression of bias 436 and movement of valve stem 434 towards bottom 410 to an open position. At the same time, the spring constant of bias 332 with respect to the spring constant of bias 436 is such that engagement of pin 454 against plunger 330 results in compression of bias 332 and movement of plunger 330 to an open state. In other embodiments, bias 436 may have other configurations.

FIG. 10 illustrates system 310 of fluid supply 314 connected to fluid receiver 312. FIG. 10 illustrates the supply of fluid to receiver 222. As shown by FIG. 10, fluid supply 314 is brought into mating, interlocking or coupled relationship with respect to fluid receiver 312. This results in needle 329 being inserted through opening 418. During such insertion of needle 329 through opening 418, seal 430 seals against sides of needle 329. At the same time, pin 454 exerts a force upon plunger 330 to compress bias 332 so as to open opening 342 of needle 329. Plunger 330 and bias 332 also exert force upon pin 454 so as to move valve stem 434 against bias 332 to the open position. As a result, a fluid passage is formed from the interior 422 of bag 402 through opening 438 into valve body 432, along flow passages 458 into interior 340 of needle 329 and through the port of fitting 362 to marking device 120 (or other fluid consuming devices of receiver 312).

In response to entry of commands from a user or external electronic device or in response to signals from one or more sensors indicating proper connection of fluid supply 314 to receiver 312, controller 38 (shown in FIG. 4) generates control signals directing pressure source 136 to supply pressurized fluid to the interior 416 of container 400. The pressurization of interior 416 exerts a force against exterior 424 of bag 402 to compress or squeeze fluid 403 out of bag 402 and along the aforementioned fluid path. Upon a sufficient volume or amount of fluid being transferred to fluid receiver 312, fluid supply 314 may be disconnected from fluid receiver 312. In response to such disconnection, bias 332 automatically returns plunger 330 to the closed position shown in FIGS. 8 and bias 436 automatically returns the valve stem 434 to the closed position shown in FIG. 11.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A fluid handling system comprising:
a needle
a valve assembly within the needle and movable from a closed state to an open state against a bias while engaging and moving a valve stem of a fluid supply from a closed state to an open state.

2. The fluid handling system of claim 1 further comprising:
a container having an opening;
a flaccid bag within the container;
a valve assembly comprising:
a seal about the opening;
a valve body about the opening and having a body interior connected to an interior of the bag;
the valve stem movably positioned within the valve body; and
a first spring resiliently biasing the valve stem into sealing engagement against the seal;
wherein the needle has a tip including a tapered interior and wherein the valve assembly comprises:
a plunger movably received within the needle, the plunger having a tapered end; and
a second spring resiliently biasing the end of the plunger into sealing engagement with the tapered interior, wherein the stem is configured to move the plunger against the second spring away from the tapered interior when received by the needle and wherein the plunger is configured to move the stem against the first spring away from the seal to open a full passage from the bag to the receiver.

3. The fluid handling system of claim 2, wherein the first spring and the second spring are configured such that the plunger is withdrawn from the tapered interior prior to withdrawal of the stem from the seal.

4. The fluid handling system of claim 2, wherein the tapered interior and the tapered end are each frustro-conical shaped.

5. The fluid handling system of claim 2 further comprising a valve retainer resiliently snapped onto the needle to capture and retain the second spring against the plunger.

6. The fluid handling system of claim 5, wherein the valve retainer includes a port and a barbed fitting about the port adapted to connect a tube to the port.

7. The fluid handling system of claim 2 wherein the valve stem includes a pin opposite the opening and configured to be engaged by the needle inserted through the opening.

8. The fluid handling system of claim 7, wherein the pin includes castellations providing a fluid path along the pin.

9. The fluid handling system of claim 2 further comprising a marking fluid within the bag.

10. The fluid handling system of claim 2, wherein the container includes a second opening in fluid communication with an exterior of the bag within a container.

11. The fluid handling system of claim 2, wherein the container comprises:
a bottom;
annular sidewalls; and
a top, the top comprising:
a top portion forming the opening;
a first annular wall about the top portion forming a cavity;
a floor portion extending from the first annular wall, the floor portion having a second opening fluidly coupled to an exterior of the bag ;
a second annular wall extending from the floor portion; and
a rim extending from the second annular wall and joined to the annular sidewalls.

12. The fluid handling system of claim 11, wherein the valve body is within the cavity and is cup shaped and wherein the valve stem has an annular blade movable into a sealing position about the opening and a pin opposite the opening.

13. The fluid handling system of claim 2, wherein the needle is configured to project into the container while the needle receives the valve stem.

14. The fluid handling system of claim 2, wherein the fluid receiver comprises a liquid marking device.

15. A method comprising:
inserting a needle of a fluid receiver through a container opening of a fluid supply;
inserting a valve stem of the fluid supply into the needle while the needle is inserted through the container opening, wherein the valve stem moves a plunger within the needle from a needle closing position to a needle opening position; and
moving the valve stem with the plunger from a fluid supply closing position to a fluid supply opening position while the valve stem is within the needle.
